(19) United States
(12) Patent Application Publication
(10) Pub. No.: US 2025/0187279 A1
(43) Pub. Date: Jun. 12, 2025

(54) SINGLE-USE CONFORMAL VACUUM BAG FOR COMPOSITE MANUFACTURING AND METHOD FOR MAKING THE SAME

(71) Applicant: JANICKI INDUSTRIES, INC., Sedro-Woolley, WA (US)

(72) Inventors: Nathan Slesinger, Sedro-Woolley, WA (US); Cody Jones, Sedro-Woolley, WA (US); David Lemme, Sedro-Woolley, WA (US); Todd Chace, Sedro-Woolley, WA (US)

(73) Assignee: JANICKI INDUSTRIES, INC., Sedro-Woolley, WA (US)

(21) Appl. No.: 18/977,675

(22) Filed: Dec. 11, 2024

Related U.S. Application Data
(60) Provisional application No. 63/608,805, filed on Dec. 11, 2023.

(51) Int. Cl. B29C 70/54; B29C 33/38

(52) U.S. Cl. CPC B29C 70/544; B29C 33/3835

(57) ABSTRACT

The present example provides a single-use engineered ultrasonically welded vacuum bag for composite bonding and lamination. A mold is provided with a single-use engineered ultrasonically welded vacuum bag and vacuum pressure to cast and consolidate a raw material in the cavity formed by the bag sealed against the mold or structure. The single-use engineered ultrasonically welded vacuum bag is pre-made in a shape that is matched to a part being formed. A close-fitting bag is made by a flat patterning process that takes a three-dimensional CAD model of the part being built and generates a flat pattern that when welded together closely fits against the part that will be built. The process of producing the single-use engineered ultrasonically welded vacuum bag advantageously uses ultrasonic joining techniques to produce a vacuum tight bag.

### TECHNICAL FIELD

This description relates generally to the fabrication of composite parts and more specifically to those in the aerospace, marine, space, industrial, and related industries.

### BACKGROUND

Composites are materials made up of two or more components that create a new material with improved properties when combined. In the most common situations composite materials include reinforced concrete (cement and rebar), reinforced fiberglass (glass fiber and resin), and carbon fiber reinforced polymer (carbon fiber and resin). As materials science has advanced, composite materials have in many instances overtaken aluminum as the production material of choice in the aviation and transportation industries, to name a few.

Uncured fiber reinforced composite materials may typically appear as one or more laminated fiber sheets surrounded by a resinous material in an uncured state. Alternatively, sheets may be built up or laid up to any desired thickness. When heated the uncured materials will soften and flow and can be molded without degradation of their properties into a desired shape. During the cure, the material typically solidifies into the finished shape.

In particular, finished fiber reinforced composite materials are known for being exceptionally strong, lightweight, chemically resistant, and thermally stable. Put together, these properties make composites an excellent choice for high-performance mechanical structures such as airplanes, automobiles, and wind turbines. Year upon year, industry adoption of composite materials has increased through continuously novel and challenging applications.

The tooling typically used to fabricate many composite parts can be subdivided into several categories including ply layup tools, skin or mold forms, curing aids, handling tools, drilling and trimming tools, assembly tools, molds and mandrels. Part production may be achieved by using these tools to create the parts. During manufacturing carbon fibers may bind with epoxy resin to create thin sheets or plies. Plies may then be arranged in layers with carbon fibers positioned at differing angles.

Once the plies have been built up, the materials are cured in a temperature and pressure-controlled environment. For example, an autoclave (a temperature and pressure-controlled chamber). Or, preferably curing outside of a pressure chamber may be accomplished with an oven or heated mold with the part laid up on the mold and a plastic sheet under vacuum disposed over the part and sealed against the mold, may be used to establish curing with structural characteristics desired (“vacuum bagging”). Typically, technicians build up laminate layers by hand and cover the laminate layers with a bag (made from sheet goods) that is cut and sealed against the mold by hand. This manual production process tends to be labor intensive resulting in increased cost.

In particular, vacuum bagging is intended to squeeze the resin-impregnated layers together against the mold pressing the laminate together, and also force the layers to conform to the shape of the mold. However, in the case of irregularly shaped parts, those having a steep vertical profile or the like, the plastic sheet may not fit closely against the laid-up part when vacuum is applied causing insufficient squeezing during curing. Also, by virtue of the hand operation inherently producing different degrees of sealing, the satisfactory parts yield, and dimensional consistency between parts may vary. It would be desirable to provide a bagging system that is easy to efficiently apply over a laid-up part, that also produces parts with improved dimensional consistency.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a single-use engineered ultrasonically welded vacuum bag for composite bonding and lamination. A mold (single or double sided) is provided with a single-use engineered ultrasonically welded vacuum bag and vacuum pressure to cast and consolidate a raw material in the cavity formed by the bag sealed against the mold. Alternatively, the single-use engineered ultrasonically welded vacuum bag may be applied to existing vehicle structure in place of a mold.

The single-use engineered ultrasonically welded vacuum bag may be pre-made in a shape that is matched to a part being formed. A close fitting bag may be made by a flat patterning process that takes a three dimensional computer aided design (“CAD”) model of the part being built and generates a flat pattern that when welded (as used herein “welded” may refer to any joining technology known to those skilled in the art that produces a vacuum tight joining of one or more materials, such as ultrasonic welding or the like) together closely fits against the part that will be built. The process of producing the single-use engineered ultrasonically welded vacuum bag advantageously uses ultrasonic joining techniques to produce a vacuum tight bag. In addition, many other components used in the curing process may be fitted to the single-use engineered ultrasonically welded vacuum bag to reduce the time it takes to produce the part and produce more uniform results.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a conventional vacuum bagging system;

FIG. 2 shows an exemplary single-use, custom engineered, ultrasonically welded, vacuum bag for composite bonding and lamination in use;

FIG. 3 shows an exemplary welded and folded single-use, custom engineered, ultrasonically welded, vacuum bag;

FIG. 4 shows an exemplary film flat pattern or cut out of a single-use, custom engineered, ultrasonically welded, vacuum bag prior to being formed into shape 400;

FIG. 5 shows an exemplary film cut out of a single-use, custom engineered, ultrasonically welded, vacuum bag with assembly and fabrication details:

FIG. 6 shows a process for creating and installing a single-use, custom engineered, ultrasonically welded, vacuum bag;

The figures show various examples of the single-use engineered ultrasonically welded vacuum bag for composite bonding and lamination, and processes of the formation thereof.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Composite materials such as carbon fiber or fiberglass combined with thermoset or thermoplastic resins typically require a vacuum bag for consolidation and cure. These vacuum bags can be made from thermoplastic film, silicone, Viton, rubber, or other materials.

When Nylon thermoplastic film vacuum bags are used, the film is usually pulled from a roll and then placed and shaped by hand for each individual part being cured. This equates to a new, unique vacuum bag being created for each article by skilled operators. Each bag may include folds, darts, and pleats to fully conform to the shape with placement and quality determined by the skill level of the operator. The cost of the bagging materials is not typically a significant factor in manufacturing but the labor to position, shape, and seal the bag can be quite significant. The quality, consistency, and repeatability of the bag can be highly dependent on the skill level of the operator. Conformability and consolidation are typically achieved by producing a vacuum bag which is oversized with tall pleats and excess material beyond the sealant line. Bags are shaped and installed as a part of the process in the production of the part.

Elastomeric vacuum bags made from silicone, Viton, rubber or similar materials can be shaped or molded to closely match the shape or contour of the part being cured. These bags typically cost more to produce than a traditional Nylon vacuum bag due to additional fabrication steps and dedicated molds but require less labor to install and are often considered reusable for several part cycles. The shape and conformability of the elastomeric bag reduces the need for highly skilled operators to install them and does not require as much time during the part manufacturing sequence to install. Elastomeric vacuum bags rely on elongation of the membrane material to conform to the part and tolerance variations part to part. This elongation limits the amount of conformability in some cases which can lead to issues with part quality. Many of these materials tend to shrink or crack which limits the number of part cycles for which they may be used requiring new bags to be produced.

This single-use engineered ultrasonically welded vacuum bag addresses many of the challenges posed by use of either traditional Nylon vacuum bags or elastomeric vacuum bags. By pre-shaping low-cost bagging materials without a mold, both the material and labor costs may be kept to a minimum. Pre-shaping the bag reduces the duration to install the bag in the manufacturing sequence, reduces the skill level of the operator required to install the bag, improves conformability of the vacuum bag with minimal excess materials, and improves consistency of the bag part to part and does not require dedicated molds.

The examples below describe a single-use engineered ultrasonically welded vacuum bag for composite bonding and lamination (the “bag” or the “vacuum bag”). Although the present examples are described and illustrated herein as being implemented in an aerospace parts molding system, the system described is provided as an example and not a limitation. As those skilled in the art will appreciate, the present examples are suitable for application in a variety of different types of fiber reinforced composite materials molding systems of parts, of various sizes and shapes.

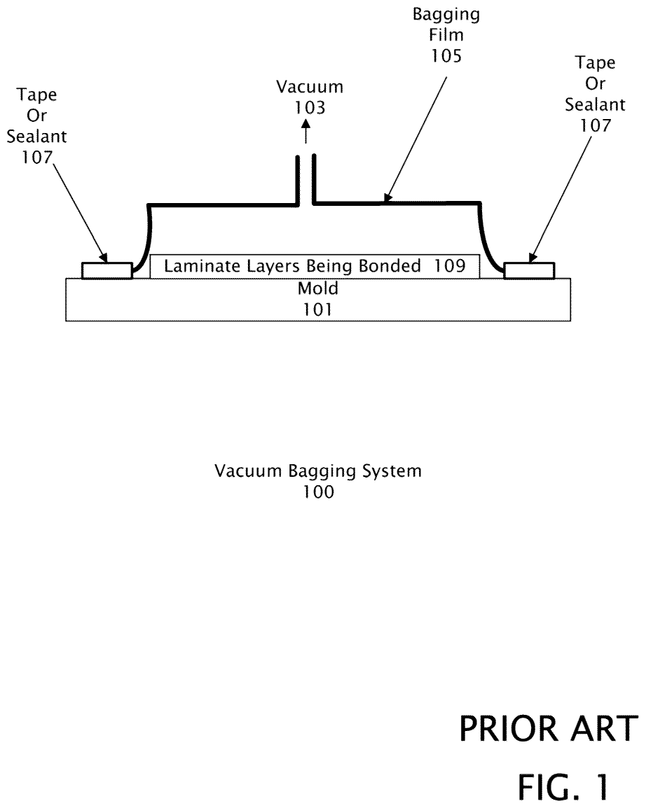

FIG. 1 shows a conventional vacuum bagging system 100. As shown a plurality of laminate layers 109 that may be impregnated with a resin (not shown) may be laid up on a mold 101. The mold 101 is typically irregular in shape, and in the molding process of turning the laminate layers 109 into a finished part typically requires forcing, or squeezing, the layers 109, together, and into the shape of the mold 101. The forcing or squeezing may typically be achieved by using force supplied by a vacuum 103. The bagging film is drawn against the laminate layers 109 due to the vacuum 103 and further draws the laminate layers 109 against the mold 101 conforming the layers 109 to the shape of the mold 101.

Bagging film 105 may typically be disposed over the laminate 109 set up on the mold 101 at the time the part is produced. The edges of the bagging film 105 may be sealed against the mold 101 by a sealant or tape 107 applied by an operator. Taping 107 the bagging film 105 to the mold 101 tends to create an airtight cavity containing the material to be bonded. As air is drawn from the cavity created around the part the film is drawn against the laminate 109 pushing the layers together and also pushing the layers 109 into the form of the mold 101. This is typically a hand operation that is time consuming and requires skilled operators to be effective.

The mold 101 is typically not planar and may include various irregular shapes (not shown). To get satisfactory distribution of pressure of the bagging film 105 against the laminate 109 a technician may typically form pleats (not shown), or otherwise manipulate the bagging film 105 when it is applied so that gaps or voids will be absent, and uniform pressure is applied. Such a hand operation is time consuming and may not produce consistent results due to variations each time the bagging around the part is created. Accordingly, it is desirable to improve this process to decrease cycle time, improve efficiency, improve consistency between molded parts, and the like.

In particular single-use engineered ultrasonically welded vacuum bags described below may include multiple advantages. Single-use engineered ultrasonically welded vacuum bags allow bags to be designed to accommodate complex geometries. Single-use engineered ultrasonically welded vacuum bags typically do not require large scale equipment or costly dedicated tooling. Single-use engineered ultrasonically welded vacuum bags are adaptable and flexible to allow for customer shape requirements. Single-use engineered ultrasonically welded vacuum bags have the ability to eliminate thermal shrinkage and webbing encountered in thermoforming. Single-use engineered ultrasonically welded vacuum bags may use industry standard bagging film, such as nylon, kapton, stretchlon, or equivalent. And finally, welded bags allow consumables to be fabricated into the bag.

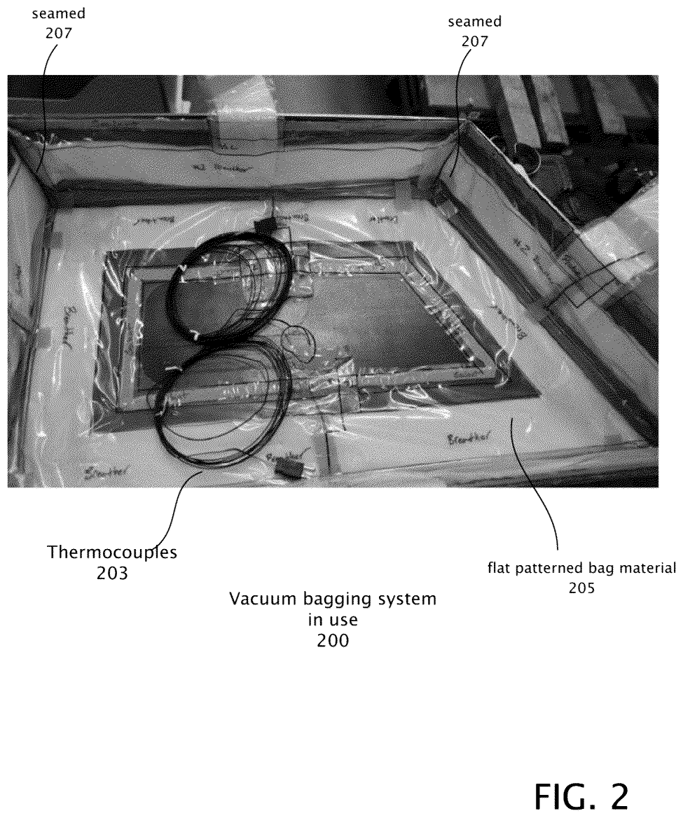

FIG. 2 shows an exemplary single-use, custom engineered, ultrasonically welded, vacuum bag for composite bonding and lamination in use 200. As shown the flat patterned bag material cut out 205 has been seamed 207, and folded, to give it a three-dimensional profile and is covering the mold underneath it. Incorporation of consumables 203, such as thermocouples and the like, may also be provided in the single-use, custom engineered, ultrasonically welded, vacuum bag for composite bonding and lamination. Additional process materials including breather, release film, and thermocouples can be pre-incorporated into the single-use, custom engineered, ultrasonically welded, vacuum bag for an out-of-the-box kit vacuum bagging system to further aid efficiency in manufacturing parts.

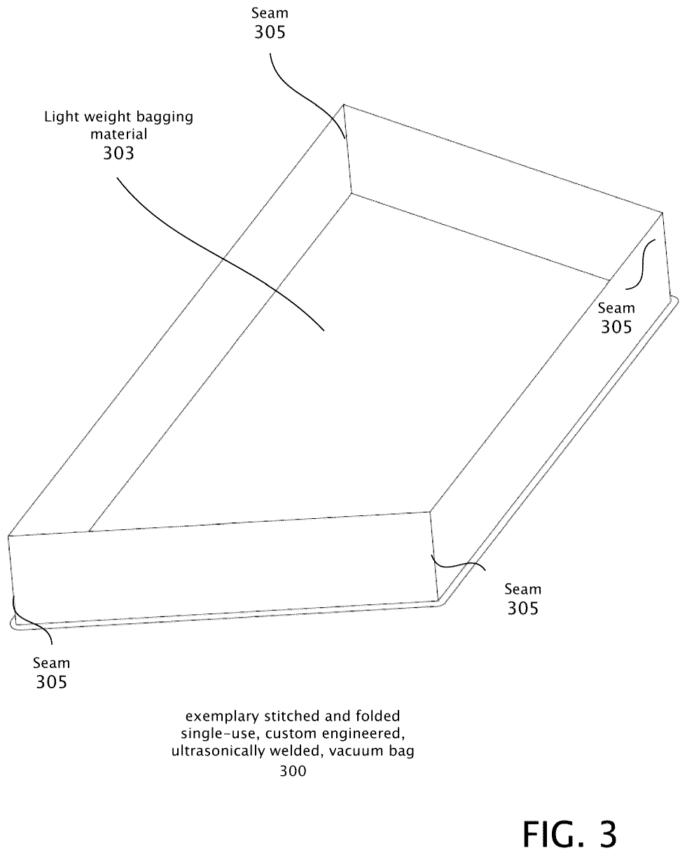

FIG. 3 shows an exemplary welded and folded single-use, custom engineered, ultrasonically welded, vacuum bag 300. The single-use, custom engineered, ultrasonically welded, vacuum bag for composite bonding and lamination solves the problem of vacuum bagging complex, and often difficult to access structures.

Folding and welding into the shape shown 300 may be done apart from the part manufacturing process. The preformed bag also reduces the experience level needed to be successful in producing parts since the bag is prefabricated in a uniform fashion.

Also, by making the bags single use, with lighter weight materials 303 allows the vacuum bags to be more conformable to complex shapes and the like. As seen the seams 305 are creating a bag with a sharp peripheral edge that may be difficult to bag manually. The single-use, custom engineered, ultrasonically welded, vacuum bag may utilize ultrasonic welding seams 305 to shape the bag which tends to be superior in speed and quality to other joining methods, such as heat seaming or sealant tape. The lightweight bagging material 303 that may be ultrasonically welded tends to be easy to work with and may also provide a desired amount of stretch or give, which may also aid in the part manufacturing process.

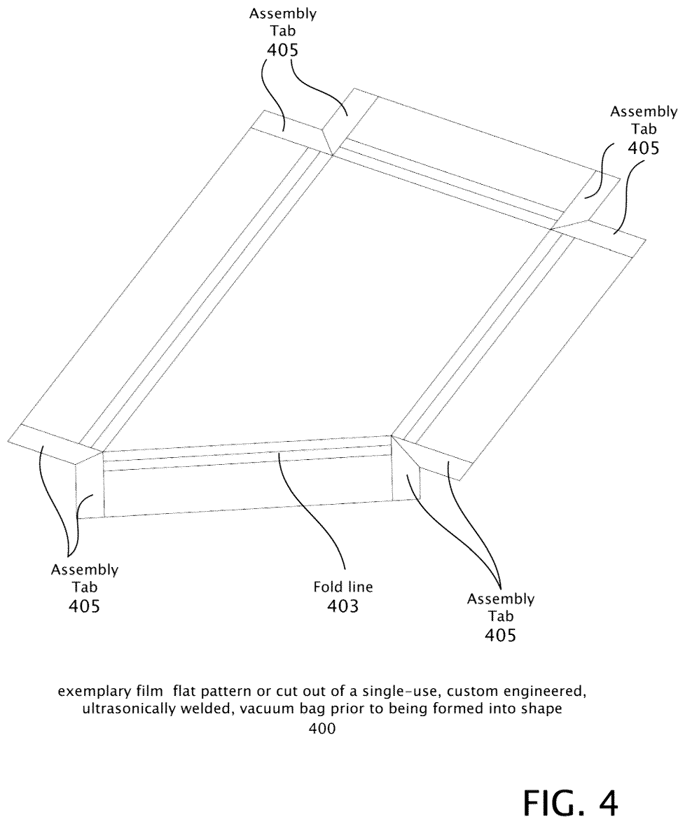

FIG. 4 shows an exemplary film cut out, or flat pattern, of a single-use, custom engineered, ultrasonically welded, vacuum bag prior to being formed into shape 400. Flat patterning is typically highly accurate and may result in a bag to accommodate complex geometries, as it is based on a CAD model of the part being produced. Establishing design rules and standards known to those skilled in the art may allow for a best fit for complex shapes. Also, the flat pattern designs can be parameterized for rapid changes and customization. Flat patterning may use CAD techniques to unfold the shape of the part modeled in the CAD data base into a flat object that may be folded into the shape of the part.

In producing the flat pattern, the CAD representation of the part is the starting point, with additional design rules applied to adjust the dimensions of the part so that the assembled bag fits over the part (cutting the flat pattern to near net size and geometry). In addition, when the flat pattern is printed out onto the bagging film assembly aids such as fold lines 403 and the like may be provided. Assembly tabs 405 and other aids may be added to aid in the assembly and welding of the bag.

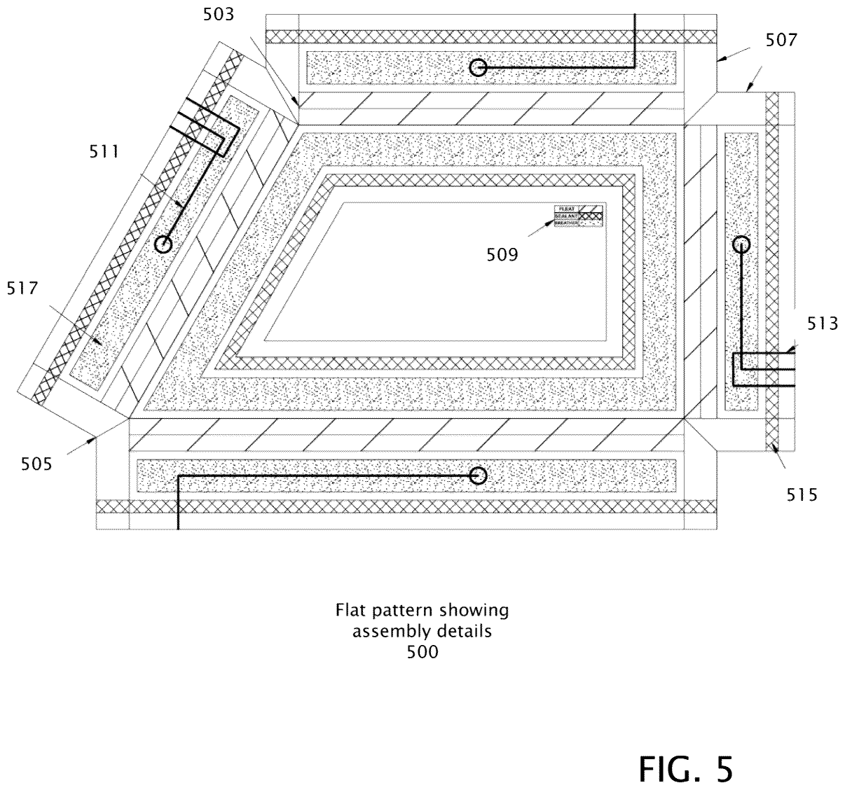

FIG. 5 shows an exemplary film cut out of a single-use, custom engineered, ultrasonically welded, vacuum bag with assembly and fabrication details 500. Such a film cut out may form a template incorporating a flat pattern profile, fold and weld lines, sealant tape locations, breather locations, vacuum source placement, thermocouple placement, reflective tape for heater integration, location and orientation markings, and the like.

Predefined pleat locations including height and shape may be provided 503.

Pleats and geometric features 502 may be incorporated to conform to the structures' shape into the flat pattern. Seams and joints 507 are incorporated that may allow assembly without creases or gaps. Incorporating joining and folding instructions 509 may be incorporated into the flat pattern. Identifying thermocouple location 512 and routing may also be identified and provided for. Vacuum pass-through locations 513 may also be identified. Identifying sealant tape locations 515 may be identified and provided for. And finally, breather locations 517 are identified and provided for.

The flat pattern may be welded into shape, and the components identified above may be installed into the folded bag, so that the bag is ready to be installed on a mold over the part that has been laid up on the mold.

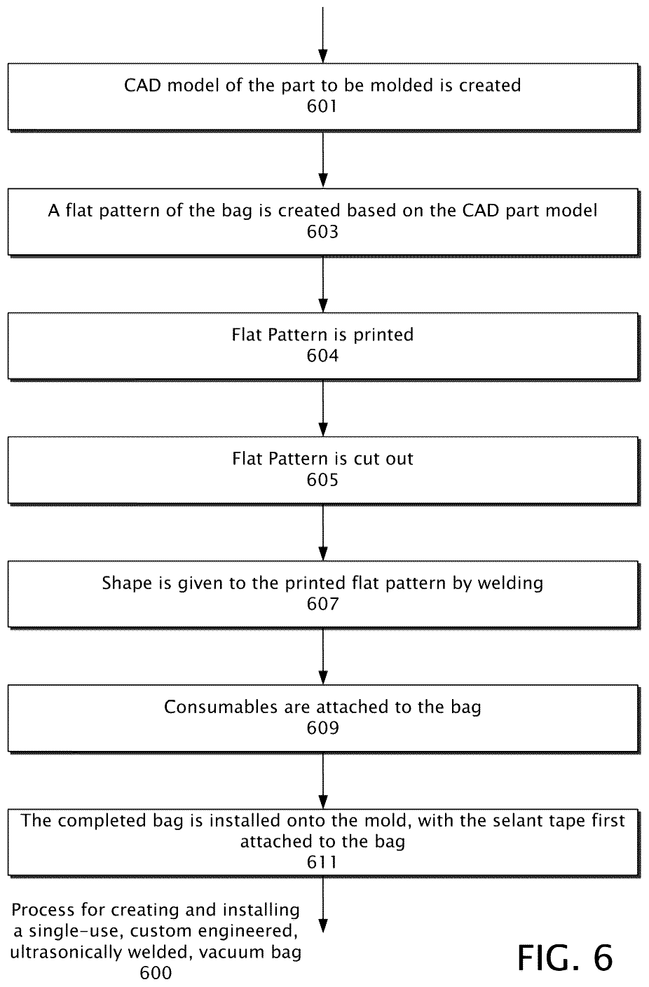

FIG. 6 shows a process for creating and installing a single-use, custom engineered, ultrasonically welded, vacuum bag 600.

At 601 a CAD model of the part to be molded is created, or for a previously designed part accessed. The model is typically a three-dimensional model of the part that may be unfolded using methods known to those skilled in the art into a planar representation of the “skin” of the surface of the part. Such a process may alternatively be called creating a baseline or initial pattern. When the planar skin or initial pattern is folded into a three-dimensional shape the part is recreated.

At 603 the skin is turned into a flat pattern that may be, when disposed over the part, would provide a loose fitting or coverage to a degree desired. The flat pattern created may also include tabs pleats and the like to aid the flat pattern to be assembled into a bag. Design rules may be formulated depending upon the application to account for size, tabbing, and the like to create an airtight bag when the flat panel is welded, bonded, sealed or otherwise put together.

At 604 printing of the flat pattern may be done directly on to the bag material with a printer (laser printer, inkjet printer, or the like). Bag material or stock is typical vacuum bag material used for composite fabrication such as nylon based thermoplastic film.

At 605 the flat patterns printed on the bagging material are then typically cut out by hand. However, the flat pattern could be machine cut, stamped or separated from the stock material by any convenient method.

At 607 the flat pattern may be assembled into a vacuum tight (when attached to the mold) bag by welding, such as ultrasonic welding, gluing, stitching or the like-in short any joining technique that is vacuum tight.

At 609 any consumables may be attached typically by hand to the vacuum tight bag (“bag” or “vacuum bag”), and away from the production of the part, so that the bag is prepped and ready for installation and use on the production floor. Consumables are the materials used during composite fabrication that may be “consumed” during the build and disposed of after the composite part has been built. General categories of consumables may include vacuum connections internal to the bag, such as, breathers, release materials, bag sealant tape, vacuum connections, thermocouples, or the like.

Breathers are materials used to create vacuum paths under the bag so everything is connected to vacuum and gases and air can be extracted. Breathers can be thermoplastic nonwoven fabric, fiberglass, or equivalent. Breathers may be ultrasonically tacked, or otherwise equivalently attached to the bag.

Release materials are a material that provides a nonstick layer to prevent other consumables from bonding to the composite part. Release materials can be a fluoropolymer, silicone, or other material that can be removed.

Bag Sealant Tape is a material that seals the vacuum bag to the tool or structure, typically a butyl rubber, or equivalent.

Vacuum connections pass through the sealant line to connect to the vacuum pump, and can be a fitting, tube, or other connection.

Thermocouples may be located as desired. By pre-attaching thermocouples to the bag accurate placement may be achieved, and if desired a common exit location through the lay-flat stringers tends to minimize leak locations.

Previously these consumable materials were all placed manually by hand, step by step, on the composite part/tool during fabrication. The single-use engineered ultrasonically welded vacuum bag for composite bonding and lamination is unique in providing a preformed shape to a specific geometry, and also by incorporating consumables into the bag which allows engineered placement and takes the time to install them off the critical path for the composite part build.

At 611 installation onto the mold is where a sealant is placed on the bag that will attach it to the mold. The seal (bag sealant tape) may be disposed at the perimeter of the bag, below the bag, between the bag and the tool/assembly-wherever a seal is desired.

Regarding the process described above, the film may be of any suitable type for the part being formed. Advantageously standard bagging film may be utilized.

In alternative examples multiple bags may be used on one part being cured. The welded bags could be used as a single bag for a single part, multiple bags for one part, multiple bags for multiple parts, a single bag for multiple parts, or the like.

Those skilled in the art will realize that the process sequences described above may be equivalently performed in any order to achieve a desired result. Also, sub-processes may typically be omitted as desired without taking away from the overall functionality of the processes described above.

1. A single-use vacuum bag for curing a composite molded part comprising:
a thermoplastic bagging film cut into a flat pattern shape of a part to be formed with near net size and geometry, marked with predefined pleat locations including height and shape, and assembled into a three-dimensional bag by bonding;
Shaped and marked in advance of use on the tool or part
at least one integrated consumable coupled to the three-dimensional bag; and
at least one integrated vacuum connection coupled to the three-dimensional bag.

2. The single-use vacuum bag for curing a composite molded part of claim 1, in which bonding is achieved by ultrasonic welding.

3. The single-use vacuum bag for curing a composite molded part of claim 1, in which the flat pattern shape includes bonding tabs.

4. The single-use vacuum bag for curing a composite molded part of claim 1, in which the three-dimensional bag when disposed on a mold is airtight.

5. The single-use vacuum bag for curing a composite molded part of claim 1, in which the flat pattern shape includes predefined pleat locations including height and shape.

6. The single-use vacuum bag for curing a composite molded part of claim 1, in which the at least one integrated consumable is sealant tape disposed at a perimeter of the three-dimensional bag.

7. The single-use vacuum bag for curing a composite molded part of claim 1, in which the at least one integrated consumable is a vacuum connection.

8. The single-use vacuum bag for curing a composite molded part of claim 1, in which the at least one integrated consumable is a breather.

9. The single-use vacuum bag for curing a composite molded part of claim 1, in which the at least one integrated consumable is a release material.

10. The single-use vacuum bag for curing a composite molded part of claim 1, in which the at least one integrated consumable is a sealant tape.

11. The single-use vacuum bag for curing a composite molded part of claim 1, in which the at least one integrated consumable is a thermocouples.

12. A method of creating a flat pattern comprising:
interrogating the geometry of a part to create an initial pattern;
increasing the size of the initial pattern so that when the net is folded, the net produces an envelope of the part;
removing the portion of the initial pattern;
Incorporating pleats and geometric features to conform to the structures' shape into the flat pattern;
incorporating seams and joints that assemble the flat pattern without creases or gaps; and
identifying thermocouple location and routing.

13. The method of creating a flat pattern of claim 12, further comprising incorporating joining and folding instructions into the flat pattern.

14. The method of creating a flat pattern of claim 12, further comprising identifying release film layer locations.

15. The method of creating a flat pattern of claim 12, further comprising identifying vacuum pass-through locations.

16. The method of creating a flat pattern of claim 12, further comprising identifying sealant tape locations.

17. The method of creating a flat pattern of claim 12, further comprising identifying breather locations.

18. The method of creating a flat pattern of claim 12, further comprising marking flat pattern features directly on to vacuum bag.

19. The method of creating a flat pattern of claim 12, in which the portion of the net removed is that of the surface of the mold.

20. A method of designing a flat pattern comprising:
interrogating the geometry of a part;
incorporating pleats and geometric features to conform the part's shape into the flat pattern;
incorporating seams and joints that assemble without creases or gaps into the flat pattern;
incorporating joining and folding instructions into the flat pattern;
identifying thermocouple location and routing;
identifying release film layer locations;
identifying vacuum pass-through locations;
identifying sealant tape locations;
identifying breather locations;
marking flat pattern features directly on to vacuum bag;
minimizing excess bag and pleat materials.
